(19) United States
(12) Patent Application Publication
(10) Pub. No.: US 2019/0387768 A1
(43) Pub. Date: Dec. 26, 2019

(54) AUTOMATED MILKSHAKE MACHINE

(71) Applicant: Levi Ezagui, Brooklyn, NY (US)

(72) Inventor: Levi Ezagui, Brooklyn, NY (US)

(21) Appl. No.: 16/447,328

(22) Filed: Jun. 20, 2019

Related U.S. Application Data
(60) Provisional application No. 62/687,500, filed on Jun. 20, 2018.
(60) Provisional application No. 62/720,657, filed on Aug. 21, 2018.

(51) Int. Cl. A23G 9/04; A47J 31/46; A47J 31/40; A23G 9/12

(52) U.S. Cl. CPC A23G 9/045; A23G 9/12; A47J 31/40; A47J 31/46

(57) ABSTRACT

An automated milkshake machine comprising an electronic input device for selecting of ingredients and milkshake parameters and a connected computer controlling device. a milkshake cup support holds a milkshake cup during filling and processing. A plurality of dispensing ingredient reservoirs, are positioned to provide milkshake ingredients to the milkshake cup, the reservoirs being electronically linked to the input device and computer controlling device for selected ingredient dispensing. A mixing structure is also linked to the input device and computer controlling device for effecting mixing with pre-selected mixing parameters of mixing speed and duration. A plurality of topping ingredient reservoirs are linked to the input and computer controlling device for selected topping dispensing. An optional transport mechanisms is provided for transport of the milkshake and/or the ingredient reservoirs during ingredient dispensing especially if multiple milkshakes are required.

This is a non-provisional application taking priority from provisional applications 62/687,500 and 62/720,657 file Jun. 20, 2018 and Aug. 21, 2018 respectively, the disclosures of which are included in their entirety herein by reference thereto.

### FIELD OF THE INVENTION

This invention relates to milkshakes and to methods and automated machinery for providing milkshakes with an efficient automated process and particularly with the maintaining of desired flavored and individual taste characteristics.

### BACKGROUND

Milkshakes are a very popular beverage and have been so for many years. The basic contents of a simple milkshake are milk and ice cream mixed or “shaken” together to form a viscous mixture of varying thicknesses, depending on the relative percentages of the milk and ice cream components and the extent of mixing. The milk ingredient can vary in type such as full fat, 2% and the like, as well as non-lactose substitutes such as almond and soy milk. The ice cream components can vary as well and includes various non dairy “ice creams” based on materials such as soy and tapioca. The most common ice cream flavors generally and, as used in milkshakes, are vanilla, chocolate and strawberry, though numerous other familiar or exotic flavor types may be utilized. Typically, milkshakes are mixed in reusable metal containers with specialized mixers (paddles on a rod) on a unitary stand and then poured into single use paper or plastic cups for consumer use.

A second type of ingredient in milkshakes is additives of varying granularities and fluidity which provide additional flavors and these commonly include nuts (generally chopped with a consistency ranging from chopped to finely ground) including coconut, solid and liquid chocolate and sprinkles, cookie crumbs and dough, coffee slush, coladas, frappucinos, chopped fruits and berries and the like, as well as myriad combinations. The actual number of ingredients possible as additives is very large and encompasses a wide range of individual tastes and preferences. For homogeneity, all the ingredients are mixed together, though the basic ice cream and milk may be mixed to achieve a desired consistency before the inclusion of the additives and dispersal mixing.

Milkshake machines have, in the past, been primarily defined as being mixing devices, typically comprising a stand with a rod and paddle mixer which is inserted into the milkshake container (typically a reusable metal cup) and activated with controlled speed and for controlled mixing times. Milkshake consistency is adjusted thereby, with variations providing regular to thick shakes.

A third type of ingredient is that of toppings which are placed on top of an already mixed milkshake and include chocolate materials such as syrups and sprinkles, berries and nuts (including ingredients used as the second type of mixed-in components) and whipped cream.

Because of the numerous ingredients possible to be added to milkshakes and with these ingredients being of widely differing processing types ranging from near solids of ice cream and nuts to granular materials and fluids (viscous and liquid like), milkshake preparation is typically done by an essentially manual process for the ingredient inclusions and additions. Premixed milkshakes and milkshakes, made by automated processes, have in the past been restricted with respect to preparation processes or have been deficient in ingredient inclusions and desired taste.

### SUMMARY OF THE INVENTION

It is an object of the invention to provide an automated milkshake preparation process and machine that is adaptable to both vending machine dispensing (single units) and store or restaurant preparation (multiple units) with enhancement in preparation control and time, variety of ingredient options and enhanced freshness and user desired taste.

It is a further object of the invention to provide the preparation process and machine whereby a consumer can control the type and amount of ingredients in a milkshake with control of milkshake consistency and desired taste.

Generally the present invention comprises an automated milkshake machine and system and preparation process with the machine system comprising:
i. an electronic input device for selecting of ingredients and milkshake parameters and a connected computer controlling device;
ii. a milkshake cup support and anchor to hold a milkshake cup during filling and processing;
iii. a plurality of dispensing ingredient reservoirs, positioned to provide milkshake ingredients to the milkshake cup, the reservoirs being electronically linked to the input device and computer controlling device for selected ingredient dispensing;
iv. a mixing structure also linked to the input device and computer controlling device for effecting mixing with pre-selected mixing parameters of mixing speed and duration;
v. a plurality of topping ingredient reservoirs linked to the input and computer controlling device for selected topping dispensing: and
vi. optional transport mechanisms for transport of the milkshake and/or the ingredient reservoirs during ingredient dispensing.

The method for automated milkshake preparation comprises the steps of:
a) selecting milkshake ingredients and amounts by inputting instructions into an electronic input device linked to a computer controlling device configured to control dispensing of selected ingredients from ingredient reservoirs into a milkshake containing cup;
b) automatically dispensing selected milkshake ingredients with instructions from the input device, as effected by the computer controlling device, into the milkshake containing cup;
c) mixing the selected milkshake ingredients which were dispensed into the milkshake cup according to parameters input into the electronic input device and as controlled by the computer controlling device, in the milkshake containing cup; and
d) providing topping ingredients with instructions from the input device and as controlled by the computer controlling device.

The above features, objectives and advantages of the machine, system and method of the invention will become more evident from the following discussion and drawings in which:

### SHORT DESCRIPTION OF THE DRAWINGS

FIG. 1 is a representative view of a tablet screen configured to provide milkshake ingredient options with a touchscreen selection;

FIG. 2 is a cutaway view of a single stationary milkshake cup surrounded by stationary ingredient reservoirs and a retractable mixing fixture in a vending machine environment;

FIG. 3 is a view of a series of stationary milkshake ingredient reservoirs with multiple milkshake cups positioned and transported on a transport conveyor belt into juxtaposition with selected ingredient reservoirs and a mixing mechanism; and

FIG. 4 is a view of stationary milkshake cups and movable ingredient reservoirs, including a mixing fixture.

### DETAILED DESCRIPTION

The milkshake preparation machine and system has the components of:
1) an electronic input device with an input selection mechanism with the device programmed to provide electronic (computer, tablet, cell phone, etc.) pre-selection of ingredients and milkshake parameters (amount and type of ingredients, mixing settings including thickness, etc.), and overall cup size;
2) a milkshake cup dispenser (optional) and cup support and anchoring element for holding an open top cup while it is being filled and the milkshake being prepared and from which the cup is removable. In one embodiment the milkshake cup is held in a stationary position during filling and processing and in another embodiment the milkshake cup is transported along a filling and processing path or in a third embodiment the machine having both stationary and transporting elements for the reservoirs and/or cup, with filling and processing;
3) a plurality of fluid (and liquid) and solid reservoirs of milkshake ingredients, with dispensing of ingredients therefrom being controlled with instructions from the input device. In one embodiment, the reservoirs surround a stationary and position-anchored milkshake cup or with input selected reservoirs being brought into filling position relative to the milkshake cup. In another embodiment the anchored cup is transported along a filling path, comprising liquid or fluid dispensers (most commonly in nozzle form) and dispensing bins of solid ingredients. The reservoirs and bins for solid ingredient are provided in common embodiments with computer controlled gravity or impelled dispensing. All of liquid, fluid and solid ingredient materials are dispensed in metered amounts which may be of gravimetric (e.g., ounces or grams) or volumetric (e.g., cubic inches or centimeters) amounts.
4) An operating computer is linked to both the input and material output devices keeps track of total ingredient volume to ensure that a selected cup size is not overfilled. In addition, with transport operations for either or both the cups and reservoirs a transport computer function is further synchronized with specific cup location to enable filling of the specific cups with selected ingredients with appropriate selected processing.

A typical single milkshake serving cup of paper or plastic ranges from about 12 ounces (about ⅓ liter) to about 30 oz. (a little less than a liter) with sizes designated as small medium and large. Common metal cups in which milkshakes are often prepared and mixed and then dispensed into serving cups, are about 30 oz. (slightly less than a liter). The main milkshake components of ice cream and milk in a typical milkshake are in the range of about 3 scoops of ice cream or about 1½ cups (softened from about 0° F. to about 20° F. for handling and mixing purposes) to about 2 oz. or ⅓ cup of milk, The ratio of milk to ice cream is determinative, to a major extent, of the shake thickness (less milk provides a thicker shake). Milkshake ingredients are mixed at a high speed for about a minute to ensure thick consistency. The higher the speed and the longer the mixing time, the thicker the shake. A common milkshake thickener is the addition of crushed ice or other thickening ingredient.

In an embodiment, a control tablet screen or computer comprises a screen with initial milkshake size options, selection of types of ice cream and milk and either options for separate amounts or fixed ratios appropriate for the size selected. The screen options include secondary ingredients with fixed weight or volume selections (non-appropriate or excessively sized options being made not available). Topping selections are also available. Mixing and thickness parameters and ingredients may be selected. Costs for all the ingredients may be provided, either individually and relative to amount, or as ingredient groupings. Computer monitored reservoirs for diverse ingredients provide feedback information such as by gravimetric analysis of current availability of ingredients for dispensing selection. If a listed ingredient is not available its option selection is deactivated, such as by being grayed out.

In an embodiment, the milkshake machine comprises either three dispensing nozzles or a single nozzle connected to a freezer unit with a dispensing selection of various ice cream flavors such as vanilla, chocolate and strawberry (higher end machines may be configured with more ice cream dispensing options). Multiple nozzles are advantageous for minimizing cleaning steps, while a single nozzle permits a wider dispensing selection. Because of the viscous nature of the ice cream, a propellant such as a pump or inert gas may be utilized for facilitated dispensing. Depending on the storage temperature of the ice cream it may be necessary to provide heated softening elements to render the ice cream softer and more amenable to dispensing, as needed. Alternatively, easier handling soft ice cream may be stored and dispensed.

The various types of milks or ersatz milks are fluid and are similarly dispensed through separate or single nozzle dispensers, though normally without the need for propellants.

In the various embodiments herein:
a) both the milkshake cup and dispensers are stationary. Dispensing nozzles or chutes from the sundry reservoirs are extendible toward the mouth of a selected container for dispensing of an ingredient and thereafter are retractable and retracted to permit dispensing of another ingredient into the mouth of the container. Limited simultaneous dispensing may be possible, depending on logistical spacing.
b) the dispensers are moved on an overhead track with dispenser nozzles and chutes while the milkshake cup remains stationary. Nozzles or dispensing chutes are moved into dispensing juxtaposition relative to the stationary cup with computer controlled and selected reservoirs sequentially dispensing ingredients into the cup;
c) the dispensers are stationary and the milkshake cup is conveyed in a stabilized holder on a track to various dispensing stations, defined as dispensing juxtaposition positions relative to a selected ingredient reservoir dispensing nozzle or chute; and
d) for space considerations and for more efficient use or time the cups and reservoirs are both moved in a computer controlled and timed (relative to selected ingredients) dispensing sequence.

After ingredient dispensing or within a sequence of dispensing certain ingredients, a mixing element is inserted into the cup and ingredients (with either movement of the cup to a mixing station or movement of the mixer element into alignment with the cup) and the ingredients are mixed for a selected time and speed (generally determined by a selected thickness consistency). Thereafter, additional materials may be added, such as toppings, including whipped cream, in an appropriate sequence. In order to preserve flavors and freshness and avoiding unwanted residues of ingredients, the reservoirs, nozzles, dispensers and the like are periodically cleaned, generally with efficiently utilized cleaners, scrubbers, chemicals, water, detergents and the like which are included in the processing line in accordance with customary cleaning procedures and scheduled maintenance.

### DETAILED DESCRIPTION OF THE DRAWINGS

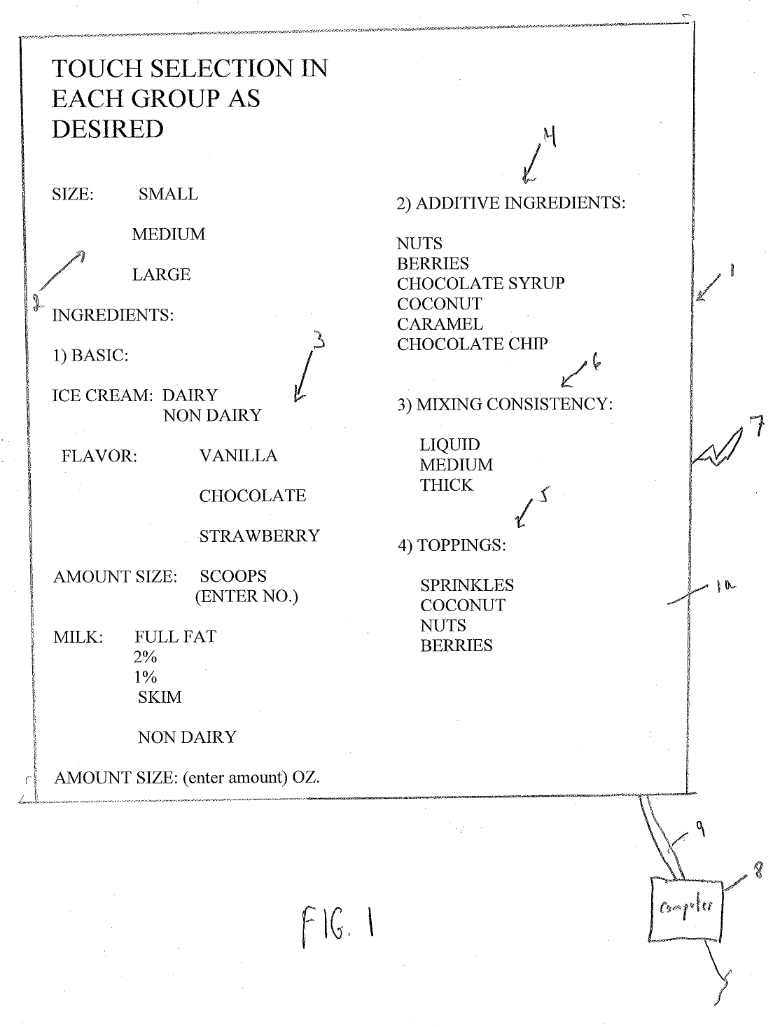

With specific reference to the drawings, FIG. 1 shows a representative (for clarity a full listing is not shown) computer tablet 1 with touch screen 1a with a menu listing of optional ingredients for selection. The ingredients are grouped into size of shake 2, required ingredients 3 of ice cream and milk and selectable types, optional ingredient additives 4, toppings 5 and shake consistency 6 with mixing parameters. A consumer or establishment employee enters the requisite parameters of milkshake size, ingredients and desired thickness into the tablet which is in turn electronically connected (via hard wire 9 or more commonly by Bluetooth 7 or similar communication) to a computer driven processor 8 which controls and synchronizes ingredient addition and amount as well as mixing processing and cup or reservoir transport (as relevant).

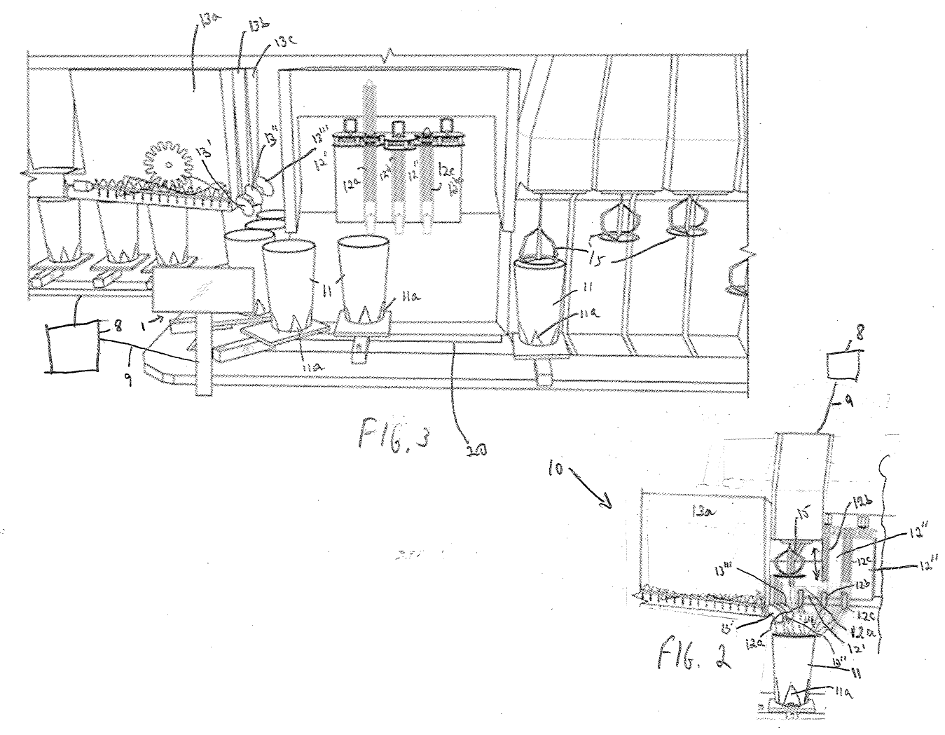

FIG. 2 depicts a milkshake system 10 amenable to a vending machine beverage dispensing system with a selected size single milkshake cup 11 being manually or automatically positioned beneath nozzles 12a-c which dispense selected amounts and types of fluid ingredients of ice cream (with selected type, flavor and amount), milk (type and amount) and other fluids such as chocolate syrup and the like. Cup 11 is of a relatively hard plastic material to resist tearing and distortion during processing steps such as mixing. Nozzle 12a which dispenses ice cream is connected to a freezer unit reservoir 12′ which maintains hard ice cream at 0° F. and dispenses it through a heating element (not shown) which raises the temperature to 20° F. to enable the ice cream to become partially fluid for dispensing. Alternatively, soft ice is initially utilized. Nozzle 12b which dispenses milk is connected to a refrigeration unit reservoir 12″ to maintain freshness of the milk. Other fluids are maintained refrigerated as appropriate and are dispensed from reservoir 12′″.

Reservoirs 13a-c are filed with sundry additive ingredients such as described above which are respectively dispensed through spout element 13′, 13″, and 13′″. The spouts and nozzles are configured to extend at least over the mouth over the positioned cup 11 (such as with telescoping elements 16) for dispensing of ingredients without spillage. Anchor element 11a extends along the base of cup 11 to prevent it from moving or tipping during filling and processing operations. After the dispensing of the ice cream, milk and selected additive ingredients into the cup 11, mixer 15, which is positioned above the mouth of cup 11, is lowered into the cup 11 (as shown by the arrow) and activated such as by spinning to mix the shake ingredient in the cup for a selected time and speed (defined by consistency). The mixer 15 is then retracted and selected topping materials are dispensed from dispensers and reservoirs such as with the additive materials. The topping dispensers may be the same as the additive dispensers or with other surrounding dispensers not shown for clarity of the other elements. The milkshake cup is then removed from the machine for consumption.

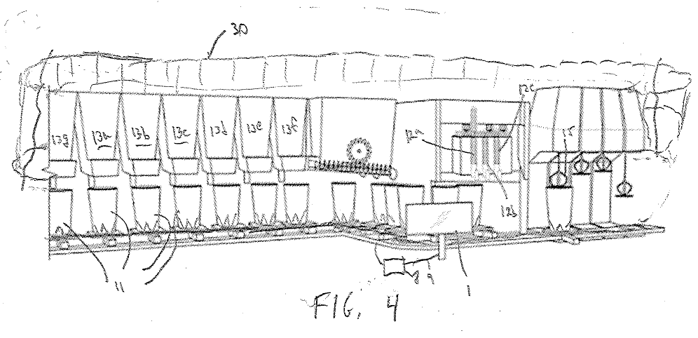

The milkshake machines shown in FIGS. 3 and 4 differ from that of the machine in FIG. 2 with respect to transport of elements (either cup or cups 11 via conveyer belt 20) or reservoirs and dispensers (overhead track 30). In FIGS. 3 and 4 multiple cups 11 are filled and processed with synchronization between instruction tablet 1 (for sequence instructions), relative transport of cups and/or reservoirs and ingredient selection and processing instructions for the individual cups. A tracking sequence is maintained to provide a consumer with the appropriate ingredient and processed selected milkshake.

It is understood that the above description and drawings are merely illustrative of the invention and that changes in structure, materials and operation may be possible without departing from the scope of the invention as defined in the following claims.

What is claimed is:

1. An automated milkshake machine comprising:
1. an electronic input device for selecting of ingredients and milkshake parameters and a connected computer controlling device;
2. a milkshake cup support and anchor to hold a milkshake cup during filling and processing;
3. a plurality of dispensing ingredient reservoirs, positioned to provide milkshake ingredients to the milkshake cup, the reservoirs being electronically linked to the input device and computer controlling device for selected ingredient dispensing;
4. a mixing structure also linked to the input device and computer controlling device for effecting mixing with pre-selected mixing parameters of mixing speed and duration;
5. a plurality of topping ingredient reservoirs linked to the input and computer controlling device for selected topping dispensing: and
6. optional transport mechanisms for transport of the milkshake and/or the ingredient reservoirs during ingredient dispensing.

2. A method for automated milkshake preparation comprises the steps of:
a) selecting milkshake ingredients and amounts by inputting instructions into an electronic input device linked to a computer controlling device configured to control dispensing of selected ingredients from ingredient reservoirs into a milkshake containing cup;
b) automatically dispensing selected milkshake ingredients with instructions from the input device, as effected by the computer controlling device, into the milkshake containing cup;
c) mixing the selected milkshake ingredients which were dispensed into the milkshake cup according to parameters input into the electronic input device and as controlled by the computer controlling device, in the milkshake containing cup; and
d) providing topping ingredients with instructions from the input device and as controlled by the computer controlling device.
